(19) United States
(12) Patent Application Publication
(10) Pub. No.: US 2014/0285633 A1
(43) Pub. Date: Sep. 25, 2014

(54) ROBOTIC SYSTEM AND IMAGE DISPLAY DEVICE

(71) Applicant: Seiko Epson Corporation, Tokyo (JP)

(72) Inventors: Kenichi Maruyama, Tatsuno-machi (JP); Kenji Onda, Matsumoto (JP)

(73) Assignee: Seiko Epson Corporation, Tokyo (JP)

(21) Appl. No.: 14/197,806

(22) Filed: Mar. 5, 2014

(30) Foreign Application Priority Data
Mar. 25, 2013 (JP) 2013-062839

(51) Int. Cl. H04N 13/02

(52) U.S. Cl. CPC H04N 13/0282
USPC 348/47

(57) ABSTRACT

A robotic system includes a robot, a display section, and a control section adapted to operate the robot, and an imaging range of a first taken image obtained by imaging an operation object of the robot from a first direction, and an imaging range of a second taken image obtained by imaging the operation object from a direction different from the first direction are displayed on the display section.

This application claims priority to Japanese Patent Application No. 2013-062839, filed Mar. 25, 2013, the entirety of which is hereby incorporated by reference.

### BACKGROUND

1. Technical Field

The present invention relates to a robotic system and an image display device.

2. Related Art

JP-A-2005-135278 (Document 1) discloses a simulation device, which disposes three-dimensional models of at least a robot, a work, and an imaging section of a visual sensor device on a screen to display the three-dimensional models at the same time, and then performs the movement simulation of the robot, wherein a device for displaying a view field of the imaging section on the screen so as to have a three-dimensional shape is further included.

In order to perform the vision control in the field of actually using the robot based on an image obtained by imaging a work object, the position and so on of the work object are figured out by obtaining the three-dimensional information of the work object from the image obtained by imaging the work object. In order to obtain the three-dimensional information of the work object, there are required at least two images obtained by imaging the work object from a plurality of directions different from each other.

In the case in which the imaging range and so on of the image having already been taken is not known when obtaining second and following images out of the at least two images, the operator cannot determine whether or not the plurality of images appropriately overlaps each other, namely whether or not the three-dimensional information of the work object can be obtained, unless the operator checks the actual imaging result.

Therefore, the operator must repeat such trial and error that the operator tries to actually obtain the plurality of images, then checks whether or not the imaging ranges of the plurality of images appropriately overlap each other, and then obtains the images again in the case in which the imaging ranges of the plurality of images do not appropriately overlap each other, and there is a problem that the load of the operator becomes heavier.

Since the invention described in Document 1 has been made for solving a problem of figuring out the three-dimensional shape of the view field in the case of taking a single image using a single camera, the imaging range can be known with respect to the single image. However, it is not considered in the invention described in Document 1 to take a plurality of images, and the problem of obtaining the three-dimensional information of the work object is not suggested.

### SUMMARY

An advantage of some aspects of the invention is to provide a robotic system and an image display device each capable of reducing the number of times of the trial and error when obtaining the three-dimensional information of the work object of the robot to thereby reduce the load of the operator.

A first aspect of the invention is directed to a robotic system including a robot, a display section, and a control section that operates the robot, wherein an imaging range of a first taken image obtained by imaging an operation object of the robot from a first direction, and an imaging range of a second taken image obtained by imaging the operation object from a direction different from the first direction are displayed on the display section.

According to the first aspect of the invention, it is possible to reduce the number of times of the trial and error performed when obtaining the three-dimensional information of the operation object of the robot to thereby reduce the load of the operator. It should be noted that the imaging of the invention is a concept including virtual imaging and actual imaging. In particular, in the case of performing the virtual imaging, it is possible to know the position and the posture of the camera, with which the appropriate stereo image can be taken, without actually operating the robot with a small number of times of the trial and error.

The second taken image may be a live-view image having temporally consecutive images. Thus, the imaging range can be known before actually taking the still image, and it is possible to reduce the number of times of the trial and error performed when obtaining the three-dimensional information of the operation object of the robot to thereby reduce the load of the operator.

The second taken image may be obtained after obtaining the first taken image. Thus, in the case of taking a plurality of images in the order of the images, it is possible to reduce the number of times of the trial and error performed when obtaining the three-dimensional information of the operation object of the robot to thereby reduce the load of the operator.

The control section may display an image showing the robot and an image showing an imaging section on the display section. Thus, it is possible to confirm the relationship between the positions of the robot and the first imaging section, and the imaging range.

The control section may display the second taken image on the display section as information representing the imaging range of the second taken image, and display information representing the imaging range of the first taken image so as to be superimposed on the second taken image. Thus, since the information representing the imaging range of the first image thus taken is displayed in the second taken image thus taken, how the imaging range of the first one and the imaging range of the second one overlap each other, and in what range the two imaging ranges overlap each other can easily be figured out.

The control section may display the information representing the imaging range of the first taken image and the information representing the imaging range of the second taken image on the display section with respective colors different from each other. Thus, the difference in imaging range between a plurality of images can easily be figured out.

The control section may display the information representing the imaging range of the first taken image and the information representing the imaging range of the second taken image on the display section with respective shapes different from each other. Thus, the difference in imaging range between a plurality of images can easily be figured out.

The control section may display a frame indicating the imaging range of the first taken image with lines on the display section as the information representing the imaging range of the first taken image. Thus, the difference in imaging range between a plurality of images can easily be figured out.

The control section may display a figure having the imaging range of the first taken image filled with a color distinguishable from a color of a range other than the imaging range of the first taken image as the information representing the imaging range of the first taken image. Thus, the difference in imaging range between a plurality of images can easily be figured out.

A second aspect of the invention is directed to an image display device including a robot control section that operates a robot, and a display control section that displays an imaging range of a first taken image obtained by imaging an operation object of the robot from a first direction, and an imaging range of a second taken image obtained by imaging the operation object from a direction different from the first direction on a display section. Thus, the imaging range of the image can be known before taking the stereo image. Therefore, it is possible to reduce the number of times of the trial and error performed when obtaining the three-dimensional information of the operation object of the robot to thereby reduce the load of the operator.

Another aspect of the invention is directed to a robot control system, adapted to obtain the three-dimensional information of an operation object using a plurality of taken images obtained by imaging the operation object of the robot a plurality of times using an imaging section, wherein information representing an imaging range of an image obtained by the imaging section imaging the operation object from a first direction, and information representing an imaging range of an image obtained by the imaging section imaging the operation object from a second direction different from the first direction are displayed on a display section.

According to this configuration, it is possible to reduce the number of times of the trial and error performed when obtaining the three-dimensional information of the operation object of the robot to thereby reduce the load of the operator. It should be noted that the imaging of the invention is a concept including virtual imaging and actual imaging. In particular, in the case of performing the virtual imaging, it is possible to know the position and the posture of the camera, with which the appropriate stereo image can be taken, without actually operating the robot with a small number of times of the trial and error.

Still another aspect of the invention is directed to a robotic system including a primary imaging section, a robot, an image acquisition section adapted to obtain a first taken image obtained by imaging an operation object of the robot from a first direction, and a second taken image obtained by the primary imaging section imaging the operation object from a direction different from the first direction, a display section, and a display control section adapted to display information representing an imaging range of the first taken image and information representing an imaging range of the second taken image on the display section.

According to this configuration, the first taken image obtained by imaging the operation object of the robot from the first direction and the second taken image obtained by the primary imaging section imaging the operation object from a direction different from the first direction are obtained, and then the information representing the imaging range of the first taken image and the information representing the imaging range of the second taken image are displayed on the display section. It should be noted that the imaging in the invention is a concept including virtual imaging and actual imaging. Thus, the imaging range of the image can be known before taking the stereo image. Therefore, it is possible to reduce the number of times of the trial and error performed when obtaining the three-dimensional information of the operation object of the robot to thereby reduce the load of the operator. In particular, in the case of performing the virtual imaging, it is possible to know the position and the posture of the camera, with which the appropriate stereo image can be taken, without actually operating the robot with a small number of times of the trial and error.

The second taken image may be a live-view image having temporally consecutive images. Thus, the imaging range can be known before actually taking the still image, and it is possible to reduce the number of times of the trial and error performed when obtaining the three-dimensional information of the operation object of the robot to thereby reduce the load of the operator.

The second taken image may also be obtained after obtaining the first taken image. Thus, in the case of taking a plurality of images in the order of the images, it is possible to reduce the number of times of the trial and error performed when obtaining the three-dimensional information of the operation object of the robot to thereby reduce the load of the operator.

The display control section may display an image showing the robot and an image showing a primary imaging section on the display section. Thus, it is possible to confirm the relationship between the positions of the robot and the first imaging section, and the imaging range.

The robot, the primary imaging section, and the operation object may be disposed in a virtual space, the robotic system may further include an overhead image generation section adapted to generate an overhead image, which is an image of the robot, the primary imaging section, and the operation object disposed in the virtual space and viewed from an arbitrary viewpoint in the virtual space, and the display control section may display the overhead image on the display section, and further display the information representing the imaging range of the first taken image and the information representing the imaging range of the second taken image so as to be superimposed on the overhead image. Thus, since the information representing the imaging range of the first image and the information representing the imaging range of the second image are displayed in the overhead image from which the positional relationship in the virtual space can be known, how the imaging ranges of the plurality of images differ from each other can easily be figured out.

The display control section may display the second taken image on the display section as the information representing the imaging range of the second taken image, and display the information representing the imaging range of the first taken image so as to be superimposed on the second taken image. Thus, since the information representing the imaging range of the first image thus taken is displayed in the second taken image thus taken, how the imaging range of the first one and the imaging range of the second one overlap each other, and in what range the two imaging ranges overlap each other can easily be figured out.

The display control section may display the information representing the imaging range of the first taken image and the information representing the imaging range of the second taken image with respective colors different from each other. Thus, the difference in imaging range between a plurality of images can easily be figured out.

The display control section may display the information representing the imaging range of the first taken image and the information representing the imaging range of the second taken image with respective shapes different from each other. Thus, the difference in imaging range between a plurality of images can easily be figured out.

The display control section may display a frame indicating the imaging range of the first taken image with lines as the information representing the imaging range of the first taken image. Thus, the difference in imaging range between a plurality of images can easily be figured out.

The display control section may display a figure having the imaging range of the first taken image filled with a color distinguishable from a color of a range other than the imaging range of the first taken image as the information representing the imaging range of the first taken image. Thus, the difference in imaging range between a plurality of images can easily be figured out.

The display control section may display a frame indicating the imaging range of the second taken image with lines as the information representing the imaging range of the second taken image. Thus, the difference in imaging range between a plurality of images can easily be figured out.

The display control section may display a figure having the imaging range of the second taken image filled with a color distinguishable from a color of a range other than the imaging range of the second taken image as the information representing the imaging range of the second taken image. Thus, the difference in imaging range between a plurality of images can easily be figured out.

The display control section may display an optical axis of the primary imaging section. Thus, the imaging direction of the taken image can easily be figured out.

The display control section may display a solid figure representing the imaging range of the first taken image as the information representing the imaging range of the first taken image. Thus, the imaging range can more easily be figured out.

The display control section may display a solid figure representing the imaging range of the second taken image as the information representing the imaging range of the second taken image. Thus, the imaging range can more easily be figured out. In particular, in the case of displaying the imaging range of the first taken image and the imaging range of the second taken image with the solid figures, the imaging ranges can easily be compared to easily figure out the difference between the imaging ranges.

The robotic system may further include an imaging information acquisition section adapted to obtain imaging information as information related to the imaging ranges of the first taken image and the second taken image. Thus, the imaging ranges can be displayed.

The primary imaging section may be disposed at least one of a head of the robot and an arm of the robot. Thus, the image can be taken by a camera provided to the robot.

The robot may have a plurality of arms, the primary imaging section may be disposed on one of the plurality of arms, and a secondary imaging section adapted to take the first taken image may be disposed on at least one of the plurality of arms other than the one of the plurality of arms. Thus, the images can be taken using the plurality of arms.

The robot may have an imaging control section adapted to change the imaging range of the primary imaging section. Thus, a plurality of images can be taken using the same imaging section.

the robotic system may further include a secondary imaging section provided to a device other than the robot, and adapted to take the first taken image. Thus, the image can be taken using a camera not provided to the robot.

The robotic system may further include a secondary imaging section adapted to take the first taken image, and, the secondary imaging section may be disposed at least one of a head of the robot and an arm of the robot. Thus, the image can be taken by a camera provided to the robot.

The robotic system may further include a secondary imaging section adapted to take the first taken image, the robot may have a plurality of arms, the secondary imaging section may be disposed on one of the plurality of arms, and the primary imaging section may be disposed on at least one of the plurality of arms other than the one of the plurality of arms. Thus, the images can be taken using the plurality of arms.

The robot may have an imaging control section adapted to change the imaging range of the secondary imaging section. Thus, a plurality of images can be taken using the same imaging section.

The primary imaging section may be provided to a device other than the robot. Thus, the image can be taken using a camera not provided to the robot.

Yet another aspect of the invention is directed to a robot adapted to obtain three-dimensional information of the operation object using a plurality of taken images obtained by imaging the operation object a plurality of times using an imaging section, wherein information representing an imaging range of an image obtained by the imaging section imaging the operation object from a first direction, and information representing an imaging range of an image obtained by the imaging section imaging the operation object from a second direction different from the first direction are displayed on a display section. Therefore, it is possible to reduce the number of times of the trial and error performed when obtaining the three-dimensional information of the operation object of the robot to thereby reduce the load of the operator. It should be noted that the imaging in the invention is a concept including virtual imaging and actual imaging. In particular, in the case of performing the virtual imaging, it is possible to know the position and the posture of the camera, with which the appropriate stereo image can be taken, without actually operating the robot with a small number of times of the trial and error.

Still yet another aspect of the invention is directed to a robot including a primary imaging section, an image acquisition section adapted to obtain a first taken image obtained by imaging an operation object from a first direction, and a second taken image obtained by the primary imaging section imaging the operation object from a direction different from the first direction, a display section, and a display control section adapted to display information representing an imaging range of the first taken image and information representing an imaging range of the second taken image on the display section. Thus, the imaging range of the image can be known before taking the stereo image. Therefore, it is possible to reduce the number of times of the trial and error performed when obtaining the three-dimensional information of the operation object of the robot to thereby reduce the load of the operator.

The second taken image may be a live-view image having temporally consecutive images. Thus, the imaging range can be known before actually taking the still image, and it is possible to reduce the number of times of the trial and error performed when obtaining the three-dimensional information of the operation object of the robot to thereby reduce the load of the operator.

The second taken image may be obtained after obtaining the first taken image. Thus, in the case of taking a plurality of images in the order of the images, it is possible to reduce the number of times of the trial and error performed when obtaining the three-dimensional information of the operation object of the robot to thereby reduce the load of the operator.

The display control section may display an image showing the robot and an image showing a primary imaging section on the display section. Thus, it is possible to confirm the relationship between the positions of the robot and the first imaging section, and the imaging range.

The primary imaging section and the operation object may be disposed in a virtual space, the robot may further include an overhead image generation section adapted to generate an overhead image, which is an image of the primary imaging section and the operation object disposed in the virtual space and viewed from an arbitrary viewpoint in the virtual space, and the display control section may display the overhead image on the display section, and further display the information representing the imaging range of the first taken image and the information representing the imaging range of the second taken image so as to be superimposed on the overhead image. Thus, since the information representing the imaging range of the first image and the information representing the imaging range of the second image are displayed in the overhead image from which the positional relationship in the virtual space can be known, how the imaging ranges of the plurality of images differ from each other can easily be figured out.

The display control section may display the second taken image on the display section as the information representing the imaging range of the second taken image, and display the information representing the imaging range of the first taken image so as to be superimposed on the second taken image. Thus, since the information representing the imaging range of the first image thus taken is displayed in the second taken image thus taken, how the imaging range of the first one and the imaging range of the second one overlap each other, and in what range the two imaging ranges overlap each other can easily be figured out.

The display control section may display the information representing the imaging range of the first taken image and the information representing the imaging range of the second taken image with respective colors different from each other. Thus, the difference in imaging range between a plurality of images can easily be figured out.

The display control section may display the information representing the imaging range of the first taken image and the information representing the imaging range of the second taken image with respective shapes different from each other. Thus, the difference in imaging range between a plurality of images can easily be figured out.

The display control section may display a frame indicating the imaging range of the first taken image with lines as the information representing the imaging range of the first taken image. Thus, the difference in imaging range between a plurality of images can easily be figured out.

The display control section may display a figure having the imaging range of the first taken image filled with a color distinguishable from a color of a range other than the imaging range of the first taken image as the information representing the imaging range of the first taken image. Thus, the difference in imaging range between a plurality of images can easily be figured out.

The display control section may display a frame indicating the imaging range of the second taken image with lines as the information representing the imaging range of the second taken image. Thus, the difference in imaging range between a plurality of images can easily be figured out.

The display control section may display a figure having the imaging range of the second taken image filled with a color distinguishable from a color of a range other than the imaging range of the second taken image as the information representing the imaging range of the second taken image. Thus, the difference in imaging range between a plurality of images can easily be figured out.

The display control section may display an optical axis of the primary imaging section. Thus, the imaging direction of the taken image can easily be figured out.

The display control section may display a solid figure representing the imaging range of the first taken image as the information representing the imaging range of the first taken image. Thus, the imaging range can more easily be figured out.

The display control section may display a solid figure representing the imaging range of the second taken image as the information representing the imaging range of the second taken image. Thus, the imaging range can more easily be figured out. In particular, in the case of displaying the imaging range of the first taken image and the imaging range of the second taken image with the solid figures, the imaging ranges can easily be compared to easily figure out the difference between the imaging ranges.

The robot may further include an imaging information acquisition section adapted to obtain imaging information as information related to the imaging ranges of the first taken image and the second taken image. Thus, the imaging ranges can be displayed.

The primary imaging section may be disposed at least one of a head of the robot and an arm of the robot. Thus, the image can be taken by a camera provided to the robot.

The robot may further include a plurality of arms, the primary imaging section may be disposed on one of the plurality of arms, and a secondary imaging section adapted to take the first taken image may be disposed on at least one of the plurality of arms other than the one of the plurality of arms. Thus, the images can be taken using the plurality of arms.

The robot may further include an imaging control section adapted to change the imaging range of the primary imaging section. Thus, a plurality of images can be taken using the same imaging section.

The robot may further include a secondary imaging section adapted to take the first taken image, and, the secondary imaging section may be disposed at least one of a head of the robot and an arm of the robot. Thus, the image can be taken by a camera provided to the robot.

The robot may further include a secondary imaging section adapted to take the first taken image, and a plurality of arms, the secondary imaging section may be disposed on one of the plurality of arms, and the primary imaging section may be disposed on at least one of the plurality of arms other than the one of the plurality of arms.

The robot may further include an imaging control section adapted to change the imaging range of the secondary imaging section. Thus, a plurality of images can be taken using the same imaging section.

Further another aspect of the invention is directed to an image display device adapted to obtain the three-dimensional information of the operation object using a plurality of taken images obtained by imaging the operation object of the robot a plurality of times using an imaging section, wherein information representing an imaging range of an image obtained by the imaging section imaging the operation object from a first direction, and information representing an imaging range of an image obtained by the imaging section imaging the operation object from a second direction different from the first direction are displayed on a display section. Thus, the imaging range of the image can be known before taking the stereo image. Therefore, it is possible to reduce the number of times of the trial and error performed when obtaining the three-dimensional information of the operation object of the robot to thereby reduce the load of the operator.

Still further another aspect of the invention is directed to an image display device including an image acquisition section adapted to obtain a first taken image obtained by imaging an operation object of a robot from a first direction, and a second taken image taken from a direction different from the first direction, a display section, and a display control section adapted to display information representing an imaging range of the first taken image and information representing an imaging range of the second taken image on the display section. Thus, the imaging range of the image can be known before taking the stereo image. Therefore, it is possible to reduce the number of times of the trial and error performed when obtaining the three-dimensional information of the operation object of the robot to thereby reduce the load of the operator.

The second taken image may be a live-view image having temporally consecutive images. Thus, the imaging range can be known before actually taking the still image, and it is possible to reduce the number of times of the trial and error performed when obtaining the three-dimensional information of the operation object of the robot to thereby reduce the load of the operator.

The second taken image may be obtained after obtaining the first taken image. Thus, in the case of taking a plurality of images in the order of the images, it is possible to reduce the number of times of the trial and error performed when obtaining the three-dimensional information of the operation object of the robot to thereby reduce the load of the operator.

The display control section may display an image showing the robot and an image showing a primary imaging section on the display section. Thus, it is possible to confirm the relationship between the positions of the robot and the first imaging section, and the imaging range.

The primary imaging section and the operation object may be disposed in a virtual space, the image display device further include an overhead image generation section adapted to generate an overhead image, which is an image of the primary imaging section and the operation object disposed in the virtual space and viewed from an arbitrary viewpoint in the virtual space, and the display control section may display the overhead image on the display section, and further display the information representing the imaging range of the first taken image and the information representing the imaging range of the second taken image so as to be superimposed on the overhead image. Thus, since the information representing the imaging range of the first image and the information representing the imaging range of the second image are displayed in the overhead image from which the positional relationship in the virtual space can be known, how the imaging ranges of the plurality of images differ from each other can easily be figured out.

The display control section may display the second taken image on the display section as the information representing the imaging range of the second taken image, and display the information representing the imaging range of the first taken image so as to be superimposed on the second taken image. Thus, since the information representing the imaging range of the first image thus taken is displayed in the second taken image thus taken, how the imaging range of the first one and the imaging range of the second one overlap each other, and in what range the two imaging ranges overlap each other can easily be figured out.

The display control section may display the information representing the imaging range of the first taken image and the information representing the imaging range of the second taken image with respective colors different from each other. Thus, the difference in imaging range between a plurality of images can easily be figured out.

The display control section may display the information representing the imaging range of the first taken image and the information representing the imaging range of the second taken image with respective shapes different from each other. Thus, the difference in imaging range between a plurality of images can easily be figured out.

The display control section may display a frame indicating the imaging range of the first taken image with lines as the information representing the imaging range of the first taken image. Thus, the difference in imaging range between a plurality of images can easily be figured out.

The display control section may display a figure having the imaging range of the first taken image filled with a color distinguishable from a color of a range other than the imaging range of the first taken image as the information representing the imaging range of the first taken image. Thus, the difference in imaging range between a plurality of images can easily be figured out.

The display control section may display a frame indicating the imaging range of the second taken image with lines as the information representing the imaging range of the second taken image. Thus, the difference in imaging range between a plurality of images can easily be figured out.

The display control section may display a figure having the imaging range of the second taken image filled with a color distinguishable from a color of a range other than the imaging range of the second taken image as the information representing the imaging range of the second taken image. Thus, the difference in imaging range between a plurality of images can easily be figured out.

The display control section may display an optical axis of the primary imaging section. Thus, the imaging direction of the taken image can easily be figured out.

The display control section may display a solid figure representing the imaging range of the first taken image as the information representing the imaging range of the first taken image. Thus, the imaging range can more easily be figured out.

The display control section may display a solid figure representing the imaging range of the second taken image as the information representing the imaging range of the second taken image. Thus, the imaging range can more easily be figured out. In particular, in the case of displaying the imaging range of the first taken image and the imaging range of the second taken image with the solid figures, the imaging ranges can easily be compared to easily figure out the difference between the imaging ranges.

The image display device may further include an imaging information acquisition section adapted to obtain imaging information as information related to the imaging ranges of the first taken image and the second taken image. Thus, the imaging ranges can be displayed.

Yet further another aspect of the invention is directed to an image display method including the steps of (a) obtaining a first taken image obtained by imaging an operation object of a robot from a first direction, (b) obtaining a second taken image taken from a direction different from the first direction, and (c) displaying information representing an imaging range of the first taken image and information representing an imaging range of the second taken image on a display section based on imaging information, which is information related to the imaging ranges of the first taken image and the second taken image. Therefore, it is possible to reduce the number of times of the trial and error performed when obtaining the three-dimensional information of the operation object of the robot to thereby reduce the load of the operator.

The step (b) and the step (c) may be performed repeatedly. Thus, the imaging range of the image can be known before taking a second still image of the stereo image.

Still yet further another aspect of the invention is directed to an image display program adapted to make an arithmetic device execute a process including the steps of (a) obtaining a first taken image obtained by imaging an operation object of a robot from a first direction, (b) obtaining a second taken image taken from a direction different from the first direction, and (c) displaying information representing an imaging range of the first taken image and information representing an imaging range of the second taken image on a display section based on imaging information, which is information related to the imaging ranges of the first taken image and the second taken image. Therefore, it is possible to reduce the number of times of the trial and error performed when obtaining the three-dimensional information of the operation object of the robot to thereby reduce the load of the operator.

The arithmetic device may execute a process of repeatedly performing the step (b) and the step (c). Thus, the imaging range of the image can be known before taking the stereo image.

### BRIEF DESCRIPTION OF THE DRAWINGS

The invention will be described with reference to the accompanying drawings, wherein like numbers reference like elements.

FIG. 1 is a diagram showing an example of a configuration of a robotic system according to a first embodiment of the invention.

FIG. 2 is a diagram showing an example of a configuration of an arm.

FIG. 3 is a block diagram showing an example of a functional configuration of the robotic system.

FIG. 4 is a diagram showing an example of a hardware configuration of a control section.

FIG. 5 is a flowchart showing an example of a flow of an imaging position determination process.

FIG. 6 is a diagram showing an example of a display screen of the robotic system.

FIG. 7 is a diagram showing an example of the display screen of the robotic system.

FIG. 8 is a diagram showing an example of the display screen of the robotic system.

FIG. 9 is a diagram showing an example of a modified example of a robot.

FIG. 10 is a diagram showing a modified example of the display screen of the robotic system.

FIG. 11 is a diagram showing a modified example of the display screen of the robotic system.

FIG. 12 is a flowchart showing an example of a flow of an imaging position determination process of a robotic system according to a second embodiment of the invention.

### DESCRIPTION OF EXEMPLARY EMBODIMENTS

Some embodiments of the invention will be explained with reference to the accompanying drawings.

### First Embodiment

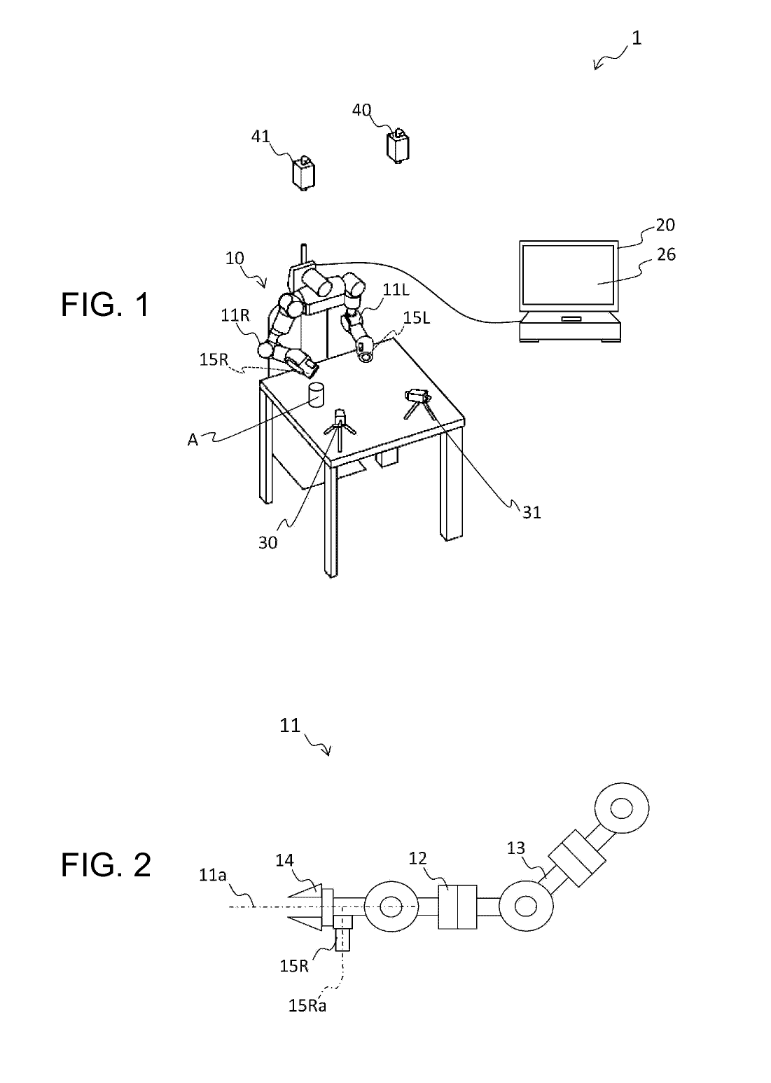

FIG. 1 is a system configuration diagram showing an example of a configuration of a robotic system 1 according to an embodiment of the invention. The robotic system 1 according to the present embodiment is mainly provided with a robot 10, a control section 20, a first imaging section 30, a second imaging section 31, a first ceiling imaging section 40, and a second ceiling imaging section 41.

The robot 10 is an arm type robot having two arms. Although in the present embodiment, the two-arm robot provided with two arms, namely a right arm 11R and a left arm 11L (hereinafter each referred to as an arm 11 in the case of expressing the right arm 11R and the left arm 11L in a lump) will be explained as an example, the number of the arms 11 of the robot 10 can also be one.

FIG. 2 is a diagram for explaining the details of the arm 11. Although FIG. 2 shows the right arm 11R as an example, the right arm 11R and the left arm 11L have the same configuration. Hereinafter, the right arm 11R will be explained as an example, and the explanation of the left arm 11L will be omitted.

The right arm 11R is provided with a plurality of joints 12, and a plurality of links 13.

On the tip of the right arm 11R, there is disposed a hand 14 (a so-called end effector) capable of grasping a work A as an operation object of the robot 10, and grasping a tool to perform a predetermined work on an object.

The joints 12 and the hand 14 are each provided with an actuator (not shown) for operating the joint 12 or the hand 14. The actuator is provided with, for example, a servomotor and an encoder. An encoder value output by the encoder is used for feedback control of the robot 10 performed by the control section 20.

A force sensor (not shown) is disposed inside the hand 14 or on the tip of the arm 11. The force sensor detects a force applied to the hand 14. As the force sensor, for example, there can be used, for example, a six-axis force sensor capable of simultaneously detecting six components, namely force components in three translational-axis directions, and moment components around the three rotational axes. Further, the physical quantity used in the force sensor is one of an electrical current, a voltage, a charge amount, an inductance, a distortion, a resistance, electromagnetic induction, magnetism, an air pressure, light, and so on. The force sensor is capable of detecting the six components by converting the desired physical quantity into an electric signal. It should be noted that the force sensor is not limited to the six-axis sensor, but can also be, for example, a three-axis sensor. Further, the position where the force sensor is disposed is not particularly limited providing the force sensor can detect the force applied to the hand 14.

Further, on the tip of the right arm 11R, there is disposed a right hand-eye camera 15R. In the present embodiment, the right hand-eye camera 15R is disposed so that the optical axis 15Ra of the right hand-eye camera 15R and the axis 11a of the arm 11 are perpendicular to each other (including the case with a slight shift). It should be noted that the right hand-eye camera 15R can also be disposed so that the optical axis 15Ra and the axis 11a are parallel to each other, or the optical axis 15Ra and the axis 11a have an arbitrary angle with each other. It should be noted that the optical axis denotes a straight line passing through the center of a lens included in an imaging section such as the hand-eye camera 15, and perpendicular to the lens surface. The right hand-eye camera 15R and the left hand-eye camera 15L correspond to the imaging section, and a primary imaging section or a secondary imaging section according to the invention.

It should be noted that the configuration of the robot 10 is explained above with respect to the principal constituents only for explaining the features of the present embodiment, but is not limited to the configuration described above. A configuration provided to a typical gripping robot is not excluded. For example, although FIG. 1 shows six-axis arms, the number of axes (the number of joints) can be increased or decreased. The number of links can also be increased or decreased. Further, the shape, the size, the arrangement, the structure, and so on of each of the various members such as the arm, the hand, the link, and the joint can arbitrarily be changed. Further, the end effector is not limited to the hand 14.

Going back to the explanation of FIG. 1, the control section 20 is provided with an output device 26 such as a display (corresponding to a display section according to the invention), and performs a process of controlling the whole of the robot 10. The control section 20 can be installed in a place distant from a main body of the robot 10, or can be incorporated in the robot 10 and so on. In the case in which the control section 20 is installed in the place distant from the main body of the robot 10, the control section 20 is connected to the robot 10 with wire or wirelessly.

The first imaging section 30, the second imaging section 31, the first ceiling imaging section 40, and the second ceiling imaging section 41 form a unit for imaging the vicinity of the work area of the robot 10 from respective angles different from each other to generate image data. The first imaging section 30, the second imaging section 31, the first ceiling imaging section 40, and the second ceiling imaging section 41 each include, for example, a camera, and are each disposed on a workbench, a ceiling, a wall, and so on. In the present embodiment, the first imaging section 30 and the second imaging section 31 are disposed on the workbench, and the first ceiling imaging section 40 and the second ceiling imaging section 41 are disposed on the ceiling. As the first imaging section 30, the second imaging section 31, the first ceiling imaging section 40, and the second ceiling imaging section 41, there can be adopted a visible-light camera, an infrared camera, or the like. The first imaging section 30, the second imaging section 31, the first ceiling imaging section 40, and the second ceiling imaging section 41 correspond to the imaging section and the secondary imaging section according to the invention.

The first imaging section 30 and the second imaging section 31 are imaging sections for obtaining images used when the robot 10 performs visual servoing. The first ceiling imaging section 40 and the second ceiling imaging section 41 are imaging sections for obtaining images for figuring out the arrangement of objects on the workbench.

The first imaging section 30 and the second imaging section 31, and the first ceiling imaging section 40 and the second ceiling imaging section 41 are each disposed so that the field angles of the images to be taken partially overlap each other to thereby make it possible to obtain information in the depth direction.

The first imaging section 30, the second imaging section 31, the first ceiling imaging section 40, and the second ceiling imaging section 41 are each connected to the control section 20, and the images taken by the first imaging section 30, the second imaging section 31, the first ceiling imaging section 40, and the second ceiling imaging section 41 are input to the control section 20. It should be noted that it can also be arranged that the first imaging section 30, the second imaging section 31, the first ceiling imaging section 40, and the second ceiling imaging section 41 are connected to the robot 10 instead of the control section 20. In this case, the images taken by the first imaging section 30, the second imaging section 31, the first ceiling imaging section 40, and the second ceiling imaging section 41 are input to the control section 20 via the robot 10.

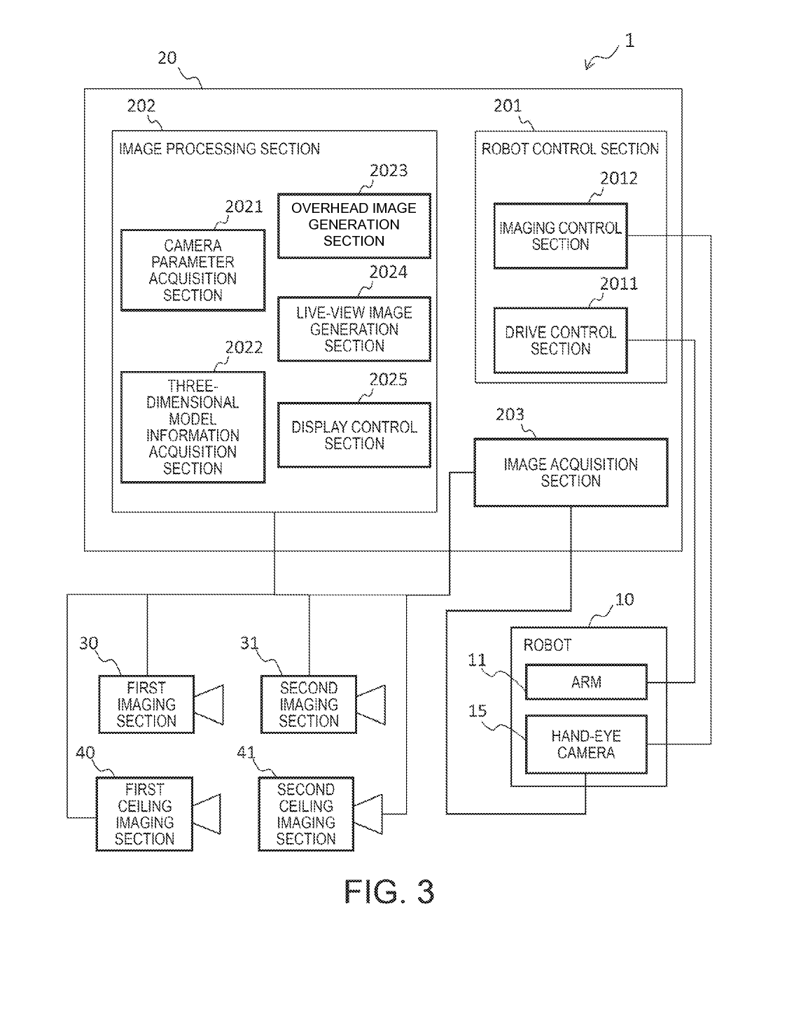

Then, an example of a functional configuration of the robotic system. 1 will be explained. FIG. 3 is a functional block diagram of the control section 20. The control section 20 mainly includes a robot control section 201, an image processing section 202, and an image acquisition section 203.

The robot control section 201 mainly includes a drive control section 2011, and an imaging control section 2012.

The drive control section 2011 controls the arms 11 and the hand 14 based on encoder values of the actuators, and sensor values of the sensors. For example, the drive control section 2011 drives the actuators so as to move the arms 11 (the hand-eye cameras 15) with the moving direction and the moving amount output from the control section 20.

The imaging control section 2012 controls the hand-eye cameras 15 to take the image an arbitrary number of times at arbitrary timings. The image taken by the hand-eye cameras 15 can be a still image or a live-view image. It should be noted that the live-view image denotes a set of images obtained by successively taking still images at a predetermined frame rate.

The image acquisition section 203 obtains the images taken by the hand-eye cameras 15, the first imaging section 30, the second imaging section 31, the first ceiling imaging section 40, and the second ceiling imaging section 41. The images obtained by the image acquisition section 203 are output to the image processing section 202.

The image processing section 202 mainly includes a camera parameter acquisition section 2021, a three-dimensional model information acquisition section 2022, an overhead image generation section 2023, a live-view image generation section 2024, and a display control section 2025.

The camera parameter acquisition section 2021 obtains internal camera parameters (a focal distance, a pixel size) and external camera parameters (a position, a posture) of each of the hand-eye cameras 15, the first imaging section 30, the second imaging section 31, the first ceiling imaging section 40, and the second ceiling imaging section 41. Since the hand-eye cameras 15, the first imaging section 30, the second imaging section 31, the first ceiling imaging section 40, and the second ceiling imaging section 41 hold the information related to the internal camera parameters and the external camera parameters (hereinafter referred to as camera parameters), the camera parameter acquisition section 2021 can obtain such information from the hand-eye cameras 15, the first imaging section 30, the second imaging section 31, the first ceiling imaging section 40, and the second ceiling imaging section 41. The camera parameter acquisition section 2021 corresponds to an imaging information acquisition section according to the invention. Further, the camera parameters correspond to imaging information according to the invention.

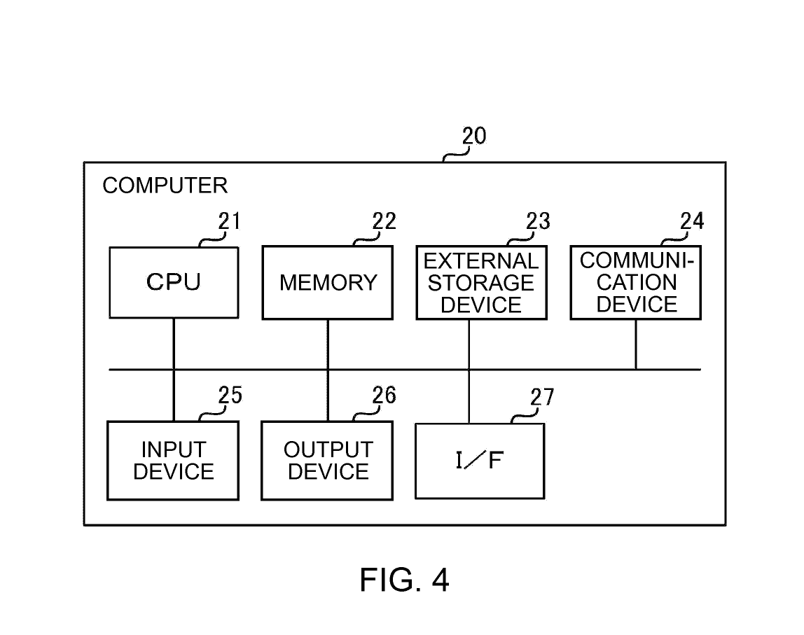

The three-dimensional model information acquisition section 2022 obtains the information of the robot 10, the workbench, the first imaging section 30, the second imaging section 31, the first ceiling imaging section 40, the second ceiling imaging section 41, the work A, and so on. The three-dimensional model denotes a data file (three-dimensional CAD data) generated using, for example, CAD (computer aided design) software. The three-dimensional model is configured by combining a number of polygons (e.g., triangles) formed by connecting structure points (vertexes). The three-dimensional model information acquisition section 2022 obtains the information of the three-dimensional model, which is stored in an external device not shown connected to the control section 20, directly or via a network. It should be noted that the three-dimensional model information acquisition section 2022 can also be arranged to obtain the information of the three-dimensional model stored in the memory 22 or an external storage device 23 (see FIG. 4).

It should be noted that it is also possible to adopt a configuration in which the three-dimensional model is generated using the CAD software introduced in the control section 20 instead of the configuration in which the three-dimensional model information acquisition section 2022 obtains the information of the three-dimensional model.

The overhead image generation section 2023 disposes the three-dimensional models of the robot 10, the workbench, the first imaging section 30, the second imaging section 31, the first ceiling imaging section 40, the second ceiling imaging section 41, the work A, and so on in a virtual space based on the information obtained by the camera parameter acquisition section 2021 and the three-dimensional model information acquisition section 2022, the image data input from the image acquisition section 203, and so on. The arrangement position of each of the three-dimensional models can be determined based on the image data input from the image acquisition section 203, and so on.

Further, the overhead image generation section 2023 generates an overhead image, which is an image observed when viewing the three-dimensional models disposed in the virtual space from an arbitrary viewpoint position in the virtual space. Since a variety of technologies having already been known can be used as the process of the overhead image generation section 2023 disposing the three-dimensional models in the virtual space, and the process of the overhead image generation section 2023 generating the overhead image, the detailed explanation thereof will be omitted. The overhead image generation section 2023 corresponds to an overhead image generation section according to the invention.

The live-view image generation section 2024 generates taken images (hereinafter referred to as virtual taken images), which are obtained when the hand-eye cameras 15, the first imaging section 30, the second imaging section 31, the first ceiling imaging section 40, and the second ceiling imaging section 41 disposed in the virtual space perform imaging in the virtual space, based on the overhead image generated by the overhead image generation section 2023 and the camera parameters obtained by the camera parameter acquisition section 2021. The virtual taken image can be a still image or a live-view image. The live-view image generation section 2024 corresponds to an image acquisition section according to the invention.

The display control section 2025 outputs the overhead image generated by the overhead image generation section 2023 and the virtual taken images generated by the live-view image generation section 2024 to the output device 26. Further, the display control section 2025 displays an image indicating the imaging range of each of the hand-eye cameras 15 on the overhead image and the virtual taken images based on the camera parameters obtained by the camera parameter acquisition section 2021. The display control section 2025 corresponds to a display control section according to the invention.

FIG. 4 is a block diagram showing an example of a schematic configuration of the control section 20. As shown in the drawings, the control section 20 constituted by, for example, a computer is provided with a central processing unit (CPU) 21 as an arithmetic device, a memory 22 constituted by a random access memory (RAM) as a volatile storage device and a read only memory (ROM) as a nonvolatile storage device, an external storage device 23, a communication device 24 for communicating with an external device such as the robot 10, an input device 25 such as a mouse or a keyboard, the output device 26 such as a display, and an interface (I/F) 27 for connecting the control section 20 and other units to each other.

Each of the functional sections described above is realized by, for example, the CPU 21 reading out a predetermined program, which is stored in the external storage device 23, on the memory 22 and so on, and then executing the program. It should be noted that the predetermined program can previously be installed in the external storage device 23 and so on, for example, or can be downloaded from a network via the communication device 24, and then installed or updated.

The configuration of the robotic system 1 described hereinabove is explained above with respect to the principal constituents only for explaining the features of the present embodiment, but is not limited to the configuration described above. For example, it is possible for the robot 10 to be provided with the control section 20, the first imaging section 30 and the second imaging section 31. Further, a configuration provided to a typical robotic system is not excluded.

Then, the characteristic process of the robotic system 1 having the above configuration according to the present embodiment will be explained.

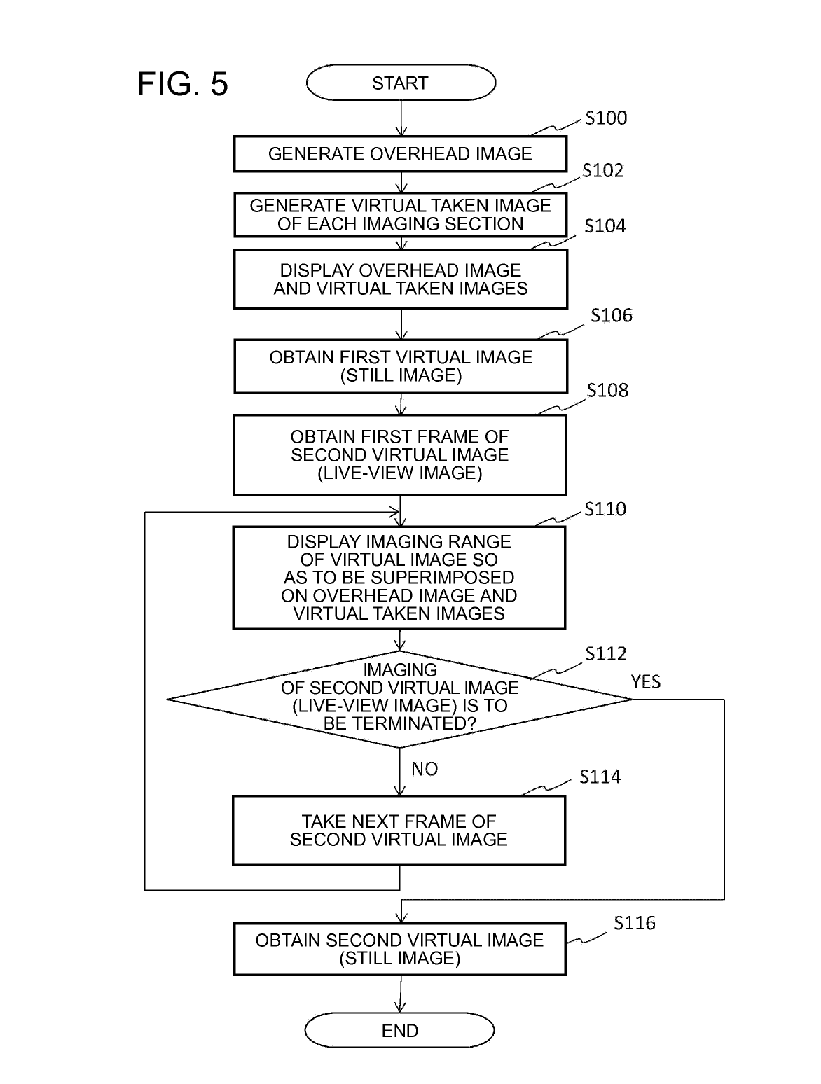

FIG. 5 is a flowchart showing a flow of a simulation process performed by the image processing section 202. The process is started in response to a starting instruction of a simulation input via, for example, a button not shown at an arbitrary timing.

In the present embodiment, the case of obtaining two images (hereinafter referred to as a stereo image) obtained by imaging the work A from angles different from each other using the right hand-eye camera 15R in order to obtain the three-dimensional information such as the position or the shape of the work A will be explained as an example.

The overhead image generation section 2023 generates (step S100) the overhead image, and the live-view image generation section 2024 generates (step S102) the virtual taken images of the hand-eye cameras 15, the first imaging section 30, the second imaging section 31, the first ceiling imaging section 40, and the second ceiling imaging section 41 as the live-view image.

The display control section 2025 generates a display image P including the overhead image generated in the step S100 and the virtual taken images generated in the step S102, and then outputs (step S104) the display image P to the output device 26.

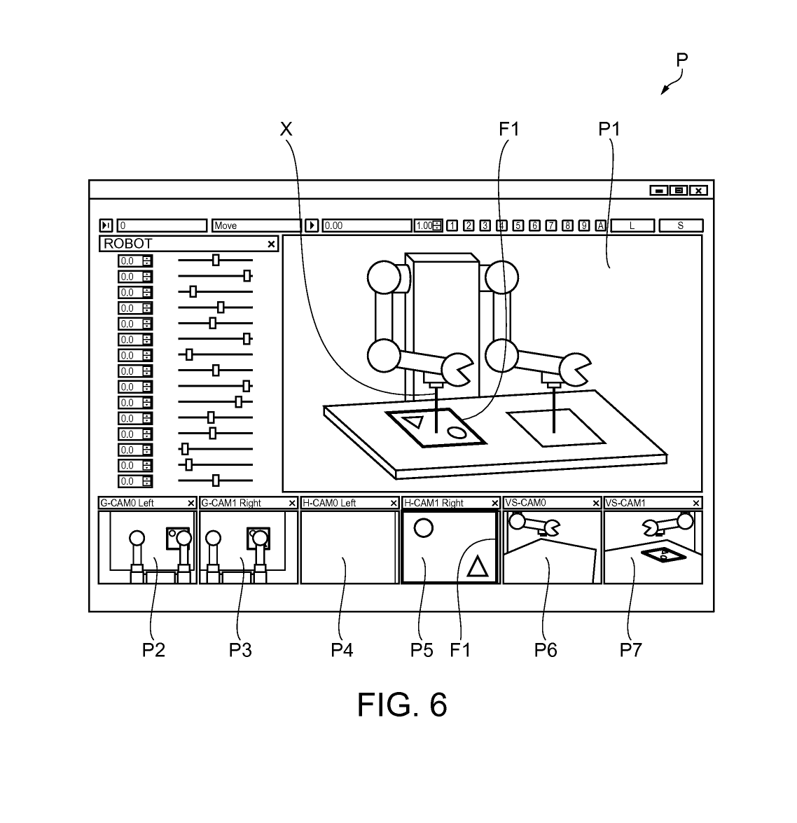

FIG. 6 is a display example of the display image P generated in the step S104. As shown in FIG. 6, an overhead image display area P1 for displaying the overhead image is disposed to an upper part of the display image P.

A virtual taken image display area P2 where the virtual taken image of the first ceiling imaging section 40 is displayed is disposed below the overhead image display area P1, and a virtual taken image display area P3 where the virtual taken image of the second ceiling imaging section 41 is displayed is disposed next to the virtual taken image display area P2. Further, a virtual taken image display area P4 where the virtual taken image of the left hand-eye camera 15L is displayed is disposed below the overhead image display area P1, and a virtual taken image display area P5 where the virtual taken image of the right hand-eye camera 15R is displayed is disposed next to the virtual taken image display area P4. Further, a virtual taken image display area P6 where the virtual taken image of the first imaging section 30 is displayed is disposed below the overhead image display area P1, and a virtual taken image display area P7 where the virtual taken image of the second imaging section 31 is displayed is disposed next to the virtual taken image display area P6.

It should be noted that since the virtual taken images are generated as the live-view image in the step S102, the display control section 104 appropriately changes the display of each of the virtual taken image display areas P2 through P7 every time the live-view image is updated in the step S104. In other words, the process in the step S102 and the step S104 is continuously performed until the process shown in FIG. 5 is terminated. It should be noted that since the method of appropriately changing the display in accordance with the live-view image has already been known, the explanation of the method will be omitted.

The live-view image generation section 2024 virtually takes (step S106) a first virtual taken image of the stereo image as a still image based on the virtual taken image of the right hand-eye camera 15R generated in the step S102. Imaging of a virtual image can be performed by the operator inputting an imaging instruction via the input device 25, or can automatically be performed by the live-view image generation section 2024. For example, in the case in which the live-view image generation section 2024 automatically performs the virtual imaging, it is also possible to arrange that the virtual imaging is performed when the work A is included in a predetermined area of the image.

The live-view image generation section 2024 virtually takes (step S108) a first image as the live-view image, namely the second virtual taken image of the stereo image, based on the virtual taken image of the right hand-eye camera 15R generated in the step S102.

It should be noted that the camera parameters of the right hand-eye camera 15R need to be changed between the virtual taken image obtained in the step S106 and the virtual taken image obtained in the step S108. The change in the camera parameters can be performed by the operator appropriately inputting the camera parameters via the input device 25, or can automatically be performed by the live-view image generation section 2024. In the case in which, for example, the live-view image generation section 2024 automatically performs the change, it is also possible to change the camera parameters by moving the right hand-eye camera 15R from the position where the virtual taken image is obtained in the step S106 rightward (leftward, upward, downward or diagonally) as much as a predetermined amount.

When changing the camera parameters of the right hand-eye camera 15R, the position and so on of the right arm 11 automatically change, and therefore, the overhead image needs to be changed. Therefore, every time the camera parameters are changed, the overhead image generation section 2023 performs the process of the step S100, and the display control section 2025 changes the display of the overhead image display area P1.

The display control section 2025 displays (step S110) the image showing the imaging range of the virtual image virtually taken in the step S106 and the image showing the imaging range of the virtual image virtually taken in the step S108 superimposed on the image displayed in each of the display areas P1 through P7 of the display image P.

FIG. 6 shows the display image P in the case in which the imaging ranges of the first virtual taken image of the stereo image and the second virtual taken image thereof roughly coincide with each other.

As the image showing the imaging range of the first virtual taken image of the stereo image virtually taken in the step S106, a frame F1 having a rectangular shape is displayed in the display image P. Further, as the image showing the imaging range of the second virtual taken image of the stereo image virtually taken in the step S108, a frame F2 having a rectangular shape is displayed in the display image P. Since the position of the frame F1 and the position of the frame F2 are roughly the same as each other, the frame F2 is omitted in FIG. 6. It should be noted that it is not necessary to omit the frame F2, and it is also possible to omit the frame F1 instead of the frame F2.

Here, a method of the display control section 2025 generating and then displaying the frames F1, F2 will be explained.

The display control section 2025 displays a quadrangular pyramid representing the view field of the right hand-eye cameras 15R in the virtual space based on the camera parameters obtained by the camera parameter acquisition section 2021. For example, the display control section 2025 determines the aspect ratio of the quadrangle of the bottom of the quadrangular pyramid based on the pixel ratio of the right hand-eye camera 15R. Then, the display control section 2025 determines the size of the bottom with respect to the distance from the vertex based on the focal distance of the right hand-eye camera 15R.

Then, in the virtual space, the display control section 2025 generates the frames F1, F2 in the place where the quadrangular pyramid thus generated, the workbench, the work A, and so on intersect with each other. By generating the frames F1, F2 as described above, the load of the process can be lightened.

Then, the display control section 2025 displays the frames F1, F2 in the display image P based on the positions of the frames F1, F2 in the virtual space. Thus, the frames F1, F2 are displayed so as to be superimposed on the image displayed in each of the display areas P1 through P7 of the display image P. It should be noted that in the present embodiment, the frame F1 is displayed with a thick line and the frame F2 is displayed with a thin line so that the frame F1 and the frame F2 can be distinguished from each other. It should be noted that it is sufficient for the frame F1 and the frame F2 to be displayed with shapes different from each other or colors different from each other so as to be able to be distinguished from each other, but the configuration thereof is not limited to one with the lines different in thickness from each other.

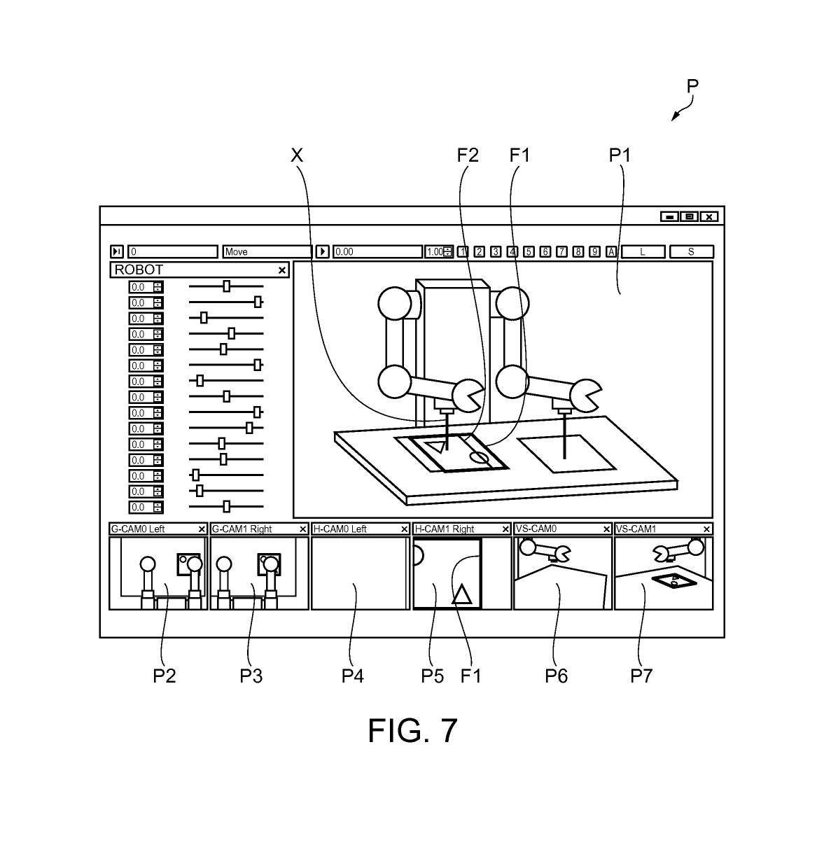

FIG. 7 shows the display image P in the case in which the right arm 11R (namely the right hand-eye camera 15R) is moved rightward in the virtual space with respect to the case shown in FIG. 6. In FIG. 7, since the right arm 11R is moved significantly, the frame F1 and the frame F2 are displayed to positions different from each other in each of the overhead image display area P1, the virtual taken image display area P2, and the virtual taken image display area P7.

Further, in the virtual taken image display area P5, one side of the frame F1 alone is displayed around the periphery of the virtual taken image display area P5 in the case shown in FIG. 6 on the one hand, in the case shown in FIG. 7, the frame F1 is displayed near to the center of the virtual taken image display area P5, on the other hand.

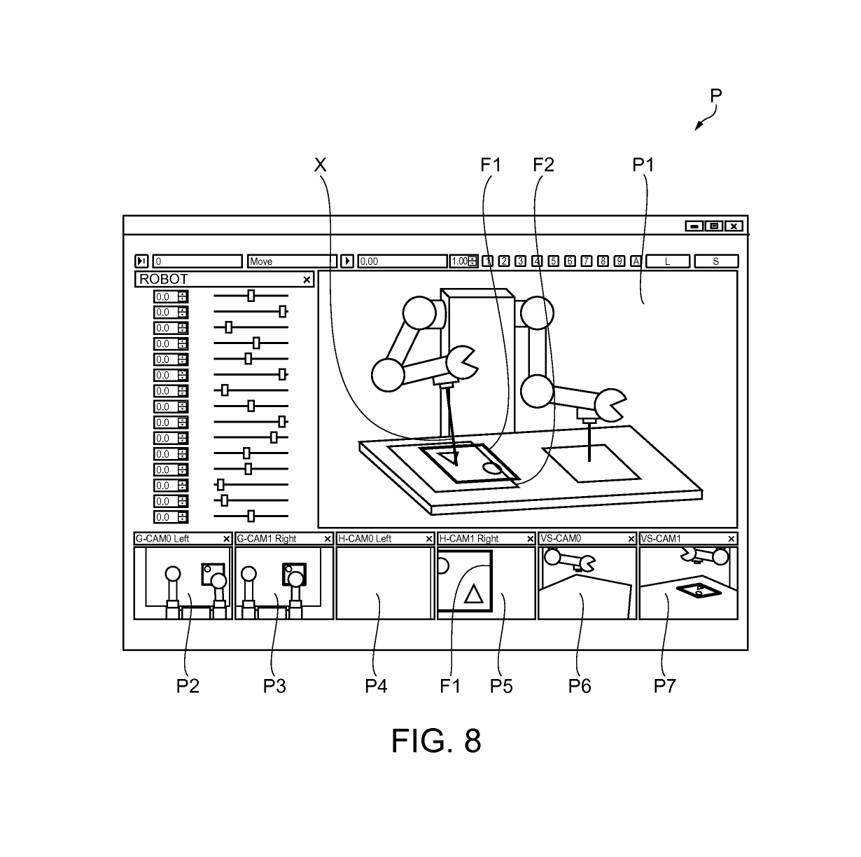

FIG. 8 shows the display image P in the case in which the right arm 11R is moved upward (in a direction of increasing the distance from the workbench) in the virtual space with respect to the case shown in FIG. 7. Since the distance between the right arm 11R and the workbench is increased in FIG. 8 compared to the case shown in FIG. 7, the size of the frame F2 becomes larger than that shown in FIG. 7.

As described above, since the frame F1 and the frame F2 are displayed in each of the overhead image display area P1, the virtual taken image display area P2, and the virtual taken image display area P7 (in particular the overhead image display area P1), how the imaging ranges of the plurality of images are different from each other can easily be figured out. Further, by displaying the frame F1 in the virtual taken image display area P5 for displaying the second taken image, how the imaging range of the first one and the imaging range of the second one overlap each other, and in what range the two imaging ranges overlap each other can easily be figured out.

It should be noted that in FIGS. 6 through 8, the optical axis X of the right hand-eye camera 15R is also displayed in a superimposed manner at the same time as displaying the frames F1, F2. Thus, the position of the camera and the imaging direction of the taken image can easily be figured out.

The display control section 2025 determines (step S112) whether or not the imaging of the live-view image of the second virtual taken image of the stereo image needs to be terminated. The display control section 2025 can determine that the imaging of the live-view image is to be terminated in the case in which the termination instruction is input via the input device 25 or the like. Alternatively, the display control section 2025 can also determine whether or not the imaging of the live-view image needs to be terminated based on the positional relationship between the frame F1 and the frame F2 displayed in the step S110. For example, it is also possible to determine whether or not the imaging of the live-view image needs to be terminated in the case in which the area where the frame F1 and the frame F2 overlap each other is roughly 80% of the size of the frames F1, F2.

In the case in which the imaging of the live-view image is not terminated (NO in the step S112), the live-view image generation section 2024 virtually takes (step S114) an image of the next frame as the live-view image, namely the second virtual taken image of the stereo image, based on the virtual taken image of the right hand-eye camera 15R generated in the step S102. Subsequently, a process in the step S110 is performed. In the step S110, the display in the virtual image display area P5 is changed to the image obtained in the step S114, and at the same time, the image showing the imaging range of the virtual image virtually taken in the step S106 and the image showing the imaging range of the virtual image virtually taken in the step S114 are displayed so as to be superimposed on the image displayed in each of the display areas P1 through P7 of the display image P.

In the case of terminating the imaging of the live-view image (YES in the step S112), the live-view image generation section 2024 virtually images (step S116) the live-view image, which has been virtually taken in the step S108, as the still image of the second virtual taken image. Subsequently, the process is terminated.

According to the present embodiment, the imaging range of the image can be known in the simulation before taking the stereo image. In particular, in the present embodiment, since the image showing the imaging range of the first image and the image showing the imaging range of the second image are displayed in the image (the overhead image display area P1 in the present embodiment) from which the positional relationship in the virtual space can be known, how the imaging ranges of the plurality of images differ from each other can easily be figured out. Therefore, it is possible to reduce the number of times of the trial and error performed when obtaining the stereo image in the simulation to thereby reduce the load of the operator.

Further, since in the present embodiment, the image showing the imaging range of the first image taken virtually is displayed in the imaging range of the second image taken virtually, how the imaging range of the first one and the imaging range of the second one overlap each other, and in what range the two imaging ranges overlap each other can easily be figured out in the simulation.

In particular, in the present embodiment, since the imaging ranges of the images having already been taken can be known when taking the stereo image by the simulation, the position and the posture of the camera, with which the appropriate stereo image can be taken, can be known by a small number of times of trial and error without actually moving the robot.

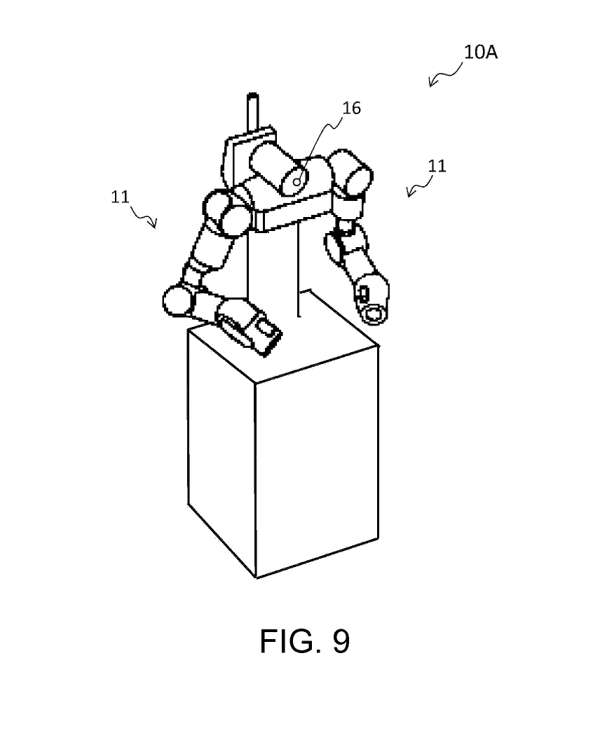

It should be noted that although in the present embodiment, the stereo image for obtaining the three-dimensional information of the work A is virtually taken by the right hand-eye camera 15R, the device for taking the stereo image is not limited to the hand-eye camera. It is also possible to, for example, dispose an imaging section 16 in a part corresponding to the head of the robot 10A as shown in FIG. 9 to take the stereo image with the imaging section 16.

Further, although in the present embodiment, both of the first image and the second image of the stereo image are virtually taken using the right hand-eye camera 15R, the imaging section for taking the first image of the stereo image and the imaging section for taking the second image thereof can be different from each other. For example, it is also possible to virtually take the first image using the second ceiling imaging section 41, and virtually take the second image using the right hand-eye camera 15R. Further, for example, it is also possible to dispose a plurality of cameras on the right arm 11R to take the respective images using the different cameras. For example, it is also possible to dispose two cameras different in focal distance from each other on the right arm 11R to virtually take the first image with the camera having the longer focal distance, and the second image with the camera having the shorter focal distance.

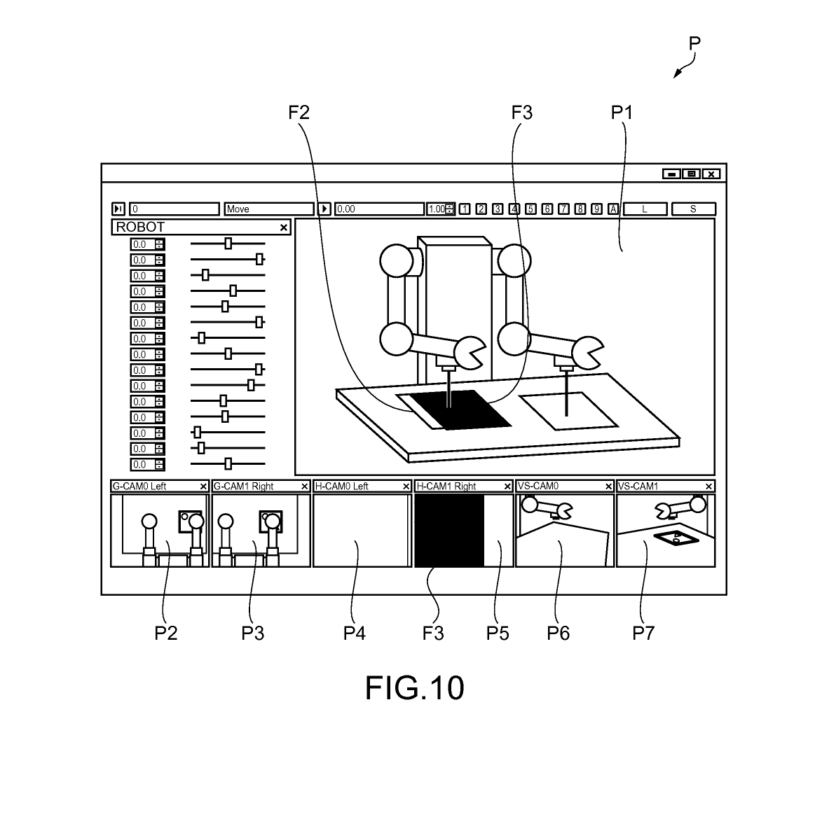

Further, although in the present embodiment, the frames F1, F2 are displayed as the information representing the imaging ranges of the stereo image, the information representing the imaging ranges of the stereo image is not limited to the frames. For example, as shown in FIG. 10, it is also possible for the display control section 2025 to indicate the imaging ranges of the stereo image by displaying a figure F3 as a quadrangle (figure) in which a part included in the imaging range in the area where the quadrangular pyramid representing the imaging range intersects with the workbench, the work A, and so on in the virtual space is filled with a color different from the color of other parts. It should be noted that the shape of the frame or the figure filled with the color is not limited to a quadrangle. Further, although the figure F3 is an image of the quadrangle inside of which is filled with one color, the configuration of filling the frame is not limited to this image. For example, it is also possible to arrange that the inside of the quadrangle is filled by providing a pattern such as a checkered pattern to the inside of the quadrangle, or hatching the inside of the quadrangle.

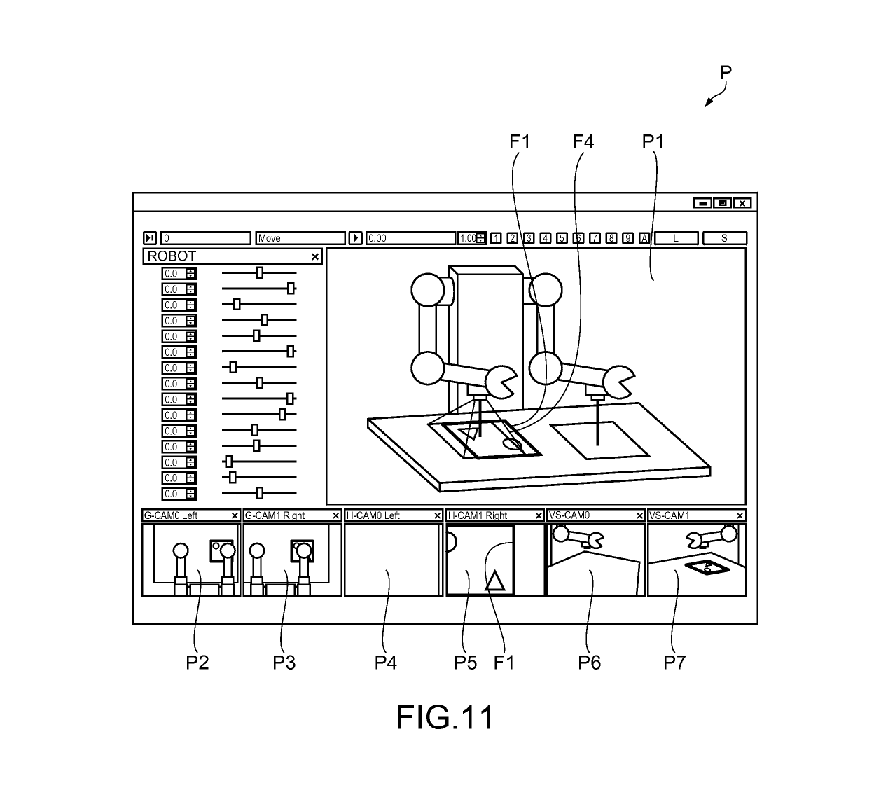

Further, for example, it is possible for the display control section 2025 to indicate the imaging ranges of the stereo image by displaying a quadrangular pyramid F4 representing the imaging range so as to be superimposed on the overhead image as shown in FIG. 11. Thus, the imaging ranges can more easily be figured out. It should be noted that the quadrangular pyramid indicating the imaging range can be generated by drawing lines connecting an arbitrary point on the optical axis and the vertexes of the frame F2 (or the frame F1) to each other. The solid figure is not limited to the quadrangular pyramid, but can also be a quadrangular truncated pyramid.

Further, although in the present embodiment, the optical axis X is displayed together with the frames F1, F2 as the information representing the imaging ranges of the stereo image, the display of the optical axis is not necessary. For example, it is possible to display the figures such as frames F1, F2 alone. Alternatively, it is also possible to arrange that the optical axis X of the camera for taking the virtual taken image is displayed alone instead of the figures such as the frames F1, F2. It should be noted that in the case of displaying the optical axis X together with the frames F1, F2, there is an advantage that a larger amount of information can be obtained compared to other cases.

Further, although in the present embodiment, the first image and the second image of the stereo image are obtained sequentially, the first image and the second image are expediential, and it is also possible to arrange that the two images are taken at the same time using two imaging sections. In this case, it is possible to display the information representing the imaging ranges of the two images in a superimposed manner while taking the live-view image for each of the two images.

Further, although in the present embodiment, the first image of the stereo image is obtained as the still image and the second image of the stereo image is obtained as the live-view image, the still image and the live-view image are described as an example of the imaging configuration, and the imaging configuration of the first image and the second image of the stereo image is not limited to this example. The imaging in the invention is a concept including the case of obtaining a still image or a moving image by releasing the shutter, and the case of obtaining the live-view image without releasing the shutter.

Further, although in the present embodiment, the stereo image is taken for figuring out the position, the shape, and so on of the work A in the state in which the robot 10, the first imaging section 30, the second imaging section 31, the first ceiling imaging section 40, the second ceiling imaging section 41, and so on have already been arranged, the purpose of taking the stereo image is not limited thereto. For example, it is also possible to tentatively dispose the first imaging section 30 and the second imaging section 31 in the virtual space to display the imaging ranges of the first imaging section 30 and the second imaging section 31 so as to be superimposed on the overhead image in the state in which the arrangement positions of the first imaging section 30 and the second imaging section 31 are not fixed, and then determine the arrangement positions of the first imaging section 30 and the second imaging section 31 while looking at the imaging ranges.

Further, although in the present embodiment, the explanation is presented taking the stereo image composed of two images as an example, the number of the images constituting the stereo image is not limited to two.

### Second Embodiment

Although the first embodiment of the invention has the configuration of displaying the image showing the imaging range when virtually taking the stereo image using the simulation, the case of displaying the image showing the imaging range is not limited to the case of taking the image using the simulation.

The second embodiment of the invention has a configuration of displaying the image showing the imaging range when taking an actual image. Hereinafter, a robotic system. 2 according to the second embodiment will be explained. It should be noted that the configuration of the robotic system 2 is the same as the configuration of the robotic system 1, and therefore, the explanation thereof will be omitted. Further, regarding the action of the robotic system 2, the same parts as those of the first embodiment will be denoted with the same reference symbols, and the explanation thereof will be omitted.

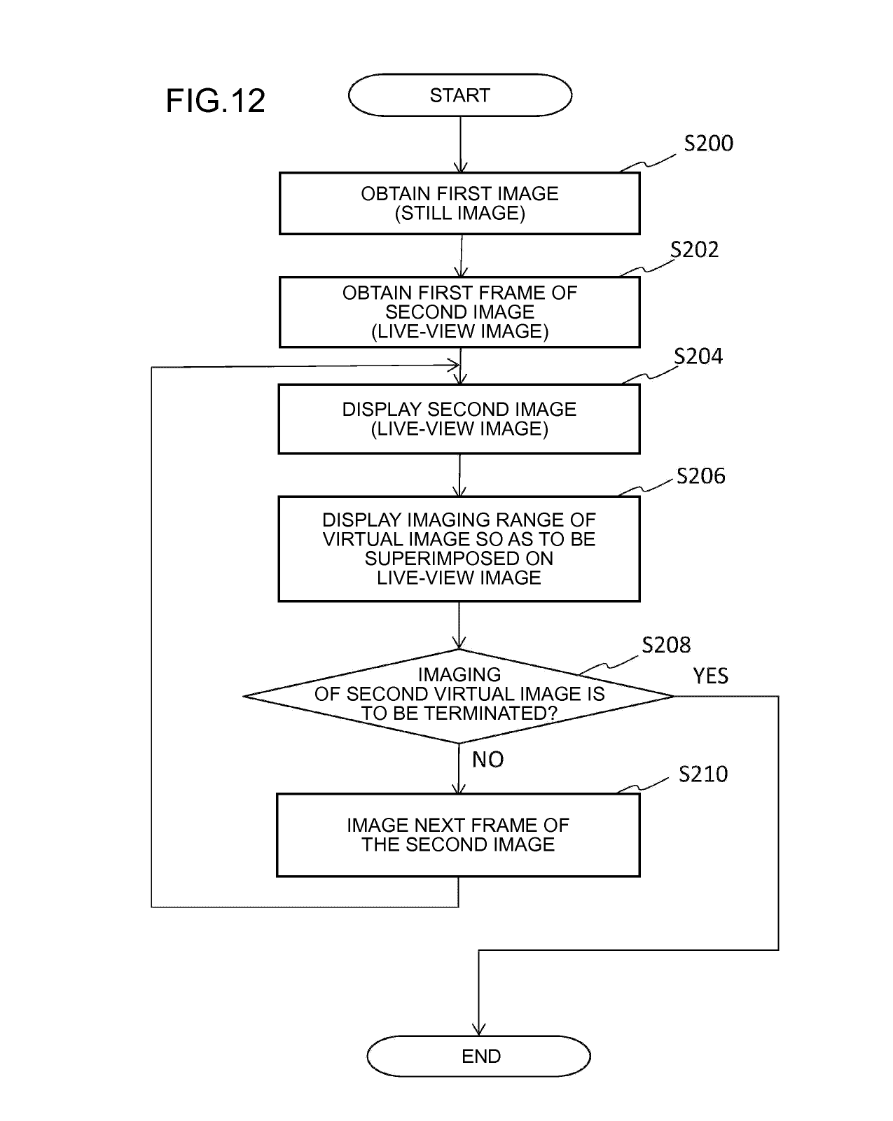

FIG. 12 is a flowchart showing a flow of the process of the image processing section 202 displaying the image showing the range of the taken image based on the image taken actually. The process is started in response to, for example, the fact that the first image of the stereo image is actually taken.

When the imaging control section 2012 controls the right hand-eye camera 15R to output the imaging instruction of a still image, the image acquisition section 203 obtains a still image taken by the right hand-eye camera 15R, and then outputs (step S200) the still image to the image processing section 202.

When the imaging control section 2012 controls the right hand-eye camera 15R to output the imaging instruction of a live-view image, the image acquisition section 203 obtains an image of the first frame of the live-view image taken by the right hand-eye camera 15R, and then outputs (step S202) the image to the image processing section 202.

When the live-view image taken by the right hand-eye camera 15R is obtained, the display control section 2025 outputs (step S204) the image thus obtained to the output device 26. Thus, the live-view image is displayed on the output device 26. Since in the present embodiment, the imaging is performed by the right hand-eye camera 15R, the live-view image displayed at this moment is roughly equivalent to such an image as shown in the virtual taken image display area P5 in FIG. 6 and so on.

The display control section 2025 displays (step S206) the frame F1 at the position of the first image, which is obtained in the step S200, in the live-view image. The position of the frame F1 can be calculated from, for example, the moving amount of the right arm 11R and the camera parameters of the right hand-eye camera 15R. Further, the position of the frame F1 can be calculated based on the image taken in the step S200 and the overhead image generated by the overhead image generation section 2023.

The display control section 2025 determines (step S208) whether or not the imaging of the live-view image of the second taken image of the stereo image needs to be terminated. The display control section 2025 can determine that the imaging of the live-view image is to be terminated in the case in which the termination instruction is input via the input device 25 or the like similarly to the first embodiment. Alternatively, the display control section 2025 can also determine whether or not the imaging of the live-view image needs to be terminated based on the positional relationship between the imaging range of the first image and the imaging range of the second image similarly to the first embodiment.

In the case in which the imaging of the live-view image is not terminated (NO in the step S208), the imaging control section 2012 takes an image of the next frame as the live-view image, namely the second taken image of the stereo image via the right hand-eye camera 15R, and then the image acquisition section 203 obtains (step S210) the image. Subsequently, a process in the step S204 is performed.

In the case of terminating the imaging of the live-view image (YES in the step S208), the display control section 2025 terminates the process.

According to the present embodiment, the imaging range of the image can be known before actually taking the stereo image. Therefore, it is possible to reduce the number of times of the trial and error performed when obtaining the second and the subsequent images of the stereo image to thereby reduce the load of the operator. In particular, since the information representing the imaging range of the first image thus taken is displayed in the second taken image thus taken, how the imaging range of the first one and the imaging range of the second one overlap each other, and in what range the two imaging ranges overlap each other can easily be figured out.

It should be noted that although both of the first image and the second image of the stereo image are actually taken using the right hand-eye camera 15R in the present embodiment, it is also possible to arrange that only the first image of the stereo image is actually taken using the right hand-eye camera 15R, and subsequently perform (the process in the step S200 is performed instead of the process in the step S106 shown in FIG. 5) the display of the display image P and the frames F1, F2 using the simulation. Further, it is also possible to arrange that the first image of the stereo image is obtained using the simulation, and the second image is actually taken (the process in the step S204 shown in FIG. 10 is performed subsequently to the process in the step S106 shown in FIG. 5).

Although the invention is hereinabove explained using the embodiments, the scope of the invention is not limited to the range of the description of the embodiments described above. It is obvious to those skilled in the art that a variety of modifications and improvements can be added to the embodiments described above. Further, it is obvious from the description of the appended claims that the configurations added with such modifications or improvements are also included in the scope of the invention. In particular, although in the first and second embodiments, the case of providing the robotic system having the robot and the robot control section disposed separately from each other is described as an example, it is possible to provide the invention as the robotic system having the robot and the robot control section disposed separately from each other, the robot including the robot control section, the robot control section alone, or the robot control device including the robot control section and the imaging section. Further, the invention can also be provided as a program for controlling the robot and so on, or the storage medium storing the program.

Further, in the case of providing the invention as the robot control section, the following two cases are included in the scope of the invention:

1. the robot control section includes the imaging section; and

2. the robot control section does not include the imaging section.

Further, in the case of providing the invention as the robotic system and the robot, the following four cases are included in the scope of the invention:

1. the robot includes the imaging section and the robot control section;

2. the robot includes the imaging section, but does not include the robot control section;

3. the robot includes the robot control section, but does not include the imaging section; and

4. the robot includes neither the imaging section nor the robot control section, and the imaging section and the robot control section are included in respective housings, or the same housing.

What is claimed is:

1. A robotic system comprising:
a robot;
a display section; and
a control section that operates the robot,
wherein an imaging range of a first taken image obtained by imaging an operation object of the robot from a first direction, and an imaging range of a second taken image obtained by imaging the operation object from a direction different from the first direction are displayed on the display section.

2. The robotic system according to claim 1, wherein
the second taken image is a live-view image including temporally consecutive images.

3. The robotic system according to claim 1, wherein
the second taken image is obtained after obtaining the first taken image.

4. The robotic system according to claim 1, wherein
the control section displays an image showing the robot and an image showing an imaging section on the display section.

5. The robotic system according to claim 1, wherein
the control section displays the second taken image on the display section as information representing the imaging range of the second taken image, and displays information representing the imaging range of the first taken image so as to be superimposed on the second taken image.

6. The robotic system according to claim 1, wherein
the control section displays the information representing the imaging range of the first taken image and the information representing the imaging range of the second taken image on the display section with respective colors different from each other.

7. The robotic system according to claim 1, wherein
the control section displays the information representing the imaging range of the first taken image and the information representing the imaging range of the second taken image on the display section with respective shapes different from each other.

8. The robotic system according to claim 1, wherein
the control section displays a frame indicating the imaging range of the first taken image with lines on the display section as the information representing the imaging range of the first taken image.

9. The robotic system according to claim 1, wherein
the control section displays a figure having the imaging range of the first taken image filled with a color distinguishable from a color of a range other than the imaging range of the first taken image as the information representing the imaging range of the first taken image.

10. An image display device comprising:
a robot control section that operates a robot; and
a display control section that displays an imaging range of a first taken image obtained by imaging an operation object of the robot from a first direction, and an imaging range of a second taken image obtained by imaging the operation object from a direction different from the first direction on a display section.
